(19) United States
(12) Patent Application Publication
(10) Pub. No.: US 2011/0127769 A1
(43) Pub. Date: Jun. 2, 2011

(54) PIPE COUPLER

(76) Inventor: PETER JOHANN MEDINA, San Diego, CA (US)

(21) Appl. No.: 12/629,850

(22) Filed: Dec. 2, 2009

(51) Int. Cl. F16L 21/02; B23P 11/00

(52) U.S. Cl. 285/336; 29/525.01

(57) ABSTRACT

A pipe coupler for physically connecting and forming a pressurized seal between two sections of pipe. The pipe coupler comprises a body having a through hole, the through hole defining an inner surface of the body. Two contact seals are installed onto two sealing grooves, respectively, located around a circumference of the inner surface. Each of the two pipe sections are inserted into the through hole from opposing ends of the body and are secured to the pipe coupler using retaining fasteners through apertures located through the body. The contact seals form a pressurized seal between the outside surface of the pipes and the inner surface of the body, thereby creating a mechanical and pressurized coupling between the two pipes.

### BACKGROUND

1. Field of Use

The embodiments described herein relate to the mechanical arts. More specifically, the present invention relates to a pipe coupler for joining two sections of pipe, tubing, conduit, or the like.

2. Description of the Related Art

It can be appreciated that pipe couplers have been used for years to join two sections of pipe. Typically, these pipe couplers comprise a three-piece assembly characterized by two metal band clamps, and a cylindrical, flexible coupler generally made of silicone or rubber. There also exists rigid metal assemblies that use o-rings, sealing bodies and a clamshell clamp retainer. Additionally, there are also male-female pipe couplers that are sometimes threaded and designed to mate in a specific orientation.

The main problem with conventional pipe couplers is that they require extraneous time and increased cost in preparing the pipes to be coupled in order for the mechanisms to function effectively. Generally, machinists need to perform complex operations or use specialized tools to prepare a pipe for coupling with another pipe. The prior art generally requires that the pipe be transformed with a bead roll, or to have a metal component welded into place in order to couple two disconnected sections of pipe. These methodologies require a significant outlay in time in order to apply such processes. They also significantly increase cost by requiring the use of specialized tools and trade labor.

Another problem with conventional pipe coupler are that they are generally not designed to operate under a high working pressure.

Another problem with conventional pipe couplers is that they require near perfect alignment in order to properly mate and produce a good seal.

While these devices may be suitable for the particular purpose to which they address, they are not as suitable for joining together disconnected sections of pipe or tubing that carry gases or fluids at working pressures. What is needed then is a pipe coupler for joining two sections of pipe that is easy to install, while also providing a pressurized seal to the coupling.

### SUMMARY

An object of the embodiments described herein is to provide a pipe coupler characterized by seals and mechanical retainers that will overcome the shortcomings of prior art devices.

Another object of the embodiments described herein is to provide a pipe coupling characterized by seals and mechanical retainers for joining together disconnected sections of pipe or tubing that carry fluids at a working pressure.

Another object is to provide a pipe coupling that eliminates the need for complex pipe preparation such as welding, bead rolling or threading in order to couple the pipes.

Another object is to provide a pipe coupling that will reduce the time required to couple together sections of pipe.

Another object is to provide a pipe coupling that will reduce the cost associated with coupling sections of pipe.

Another object is to provide a pipe coupling that eliminates the need for specialty tools and tooling such as welders, bead rollers or pipe threaders in order to couple together pipes.

Another object is to provide a pipe coupling that does not require near-perfect pipe alignment in order to couple together pipes.

Another object is to provide a pipe coupling that will accommodate variations in diameters of pipes to be coupled together.

Other objects and advantages of the embodiments described herein will become obvious to the reader and it is intended that these objects and advantages are within the scope of the description herein.

In one embodiment, a pipe coupler is described that comprises a body having an outer surface and a through hole formed along a central axis of the body. The through hole defines an inner surface of the body. The body further comprises a first aperture joining the outer surface and the inner surface, a second aperture joining the outer surface and the inner surface, a first sealing groove formed along a circumference of the inner surface and a second sealing groove formed along the circumference of the inner surface. A first contact seal is installed into the first sealing groove for forming a first pressurized seal against a first pipe section while a second contact seal is installed into the second sealing groove for forming second pressurized seal against a second pipe section. The two pipes are each secured to the pipe coupler via first and second retaining fasteners that are installed through the first and second apertures.

In another embodiment, a pipe coupler is described that comprises a body having an outer surface and a through hole formed along a central axis of the body. The through hole defines an inner surface of the body. The body further comprises a first aperture joining the outer surface and the inner surface, a second aperture joining the outer surface and the inner surface, a first sealing groove formed along a circumference of the inner surface and a second sealing groove formed along the circumference of the inner surface. The pipe coupler further comprises means for forming a first pressurized seal between the inner surface and a first pipe section, means for forming a second pressurized seal between the inner surface and a second pipe section, means for retaining the first pipe section within the pipe coupler, and means for retaining the second pipe section within the pipe coupler.

In yet another embodiment, a method for manufacturing a pipe coupling is described, comprising forming first and second sealing grooves along an inner surface of a body, the inner surface formed by a through hole formed along a central axis of the body. First and second contact seals are then inserted into the first and second sealing grooves, respectively. First and second apertures are formed through the pipe coupling; each of the apertures for receiving a retaining fastener used to secure the pipe coupling to two pipe sections.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a perspective view illustrating two pipe sections connected by a pipe coupler in accordance with a first embodiment;

FIG. 2 is a cutaway view illustrating the pipe sections and the pipe coupler of FIG. 1;

FIG. 2a is a cutaway view illustrating two pipe sections, each having a different diameter, coupled together using another embodiment of pipe coupler;

FIG. 2b is a close-up, side view illustrating a depression formed on the surface of a pipe and a retaining fastener installed through an aperture;

FIG. 3 illustrates an exploded view of the pipe sections and pipe coupler of FIGS. 1 and 2; and

FIG. 4 illustrates another embodiment of a pipe coupler for capping a single pipe, tube, conduit, or the like.

### DETAILED DESCRIPTION

In view of the foregoing disadvantages inherent in the known types of pipe couplers now present in the prior art, the following description provides a new pipe coupler characterized by seals and mechanical retainers wherein the same can be utilized for joining together disconnected sections of pipe or tubing that carry gases or fluids at a working pressure. It should be understood that throughout the specification and claims, the term “pipe” is used to broadly describe a pipe, tube, pipette, conduit, cylinder, channel, or the like.

The general purpose of the embodiments described herein is to provide a new pipe coupler characterized by seals and mechanical retainers that has many of the advantages of the pipe coupler mentioned heretofore and many novel features that result in a new pipe coupler which is not anticipated, rendered obvious, suggested, or even implied by any of the prior art pipe couplers, either alone or in any combination thereof.

Generally, the pipe coupler described herein is intended to be applied to an unfinished section of pipe, tubing, conduit, or the like. In one embodiment, it can be used to cap the end of a pipe or tube, or to connect multiple sections of disconnected pipes into a common manifold arrangement. There exists a myriad of methodologies to manufacture these components. Processes that can be used include, but are not limited to, investment casting, die casting, injection molding and wrought machining. Materials that can be used can include, but are not limited to, ferrous and non-ferrous metals, plastics and advanced resin-based composites.

The embodiments discussed herein can be used in a variety of fields, such as the automotive, drilling, and plumbing fields, among others. It can be used to join large and small pipes alike, by altering the size of the various components to fit the particular application. For example, in one embodiment, the pipe coupler could be manufactured to accommodate two pipettes in an automotive application, each pipette having a diameter of one-eighth inch. In another embodiment, the pipe coupler could be sized to accommodate two pipes in an industrial facility, each pipe having a diameter of two feet.

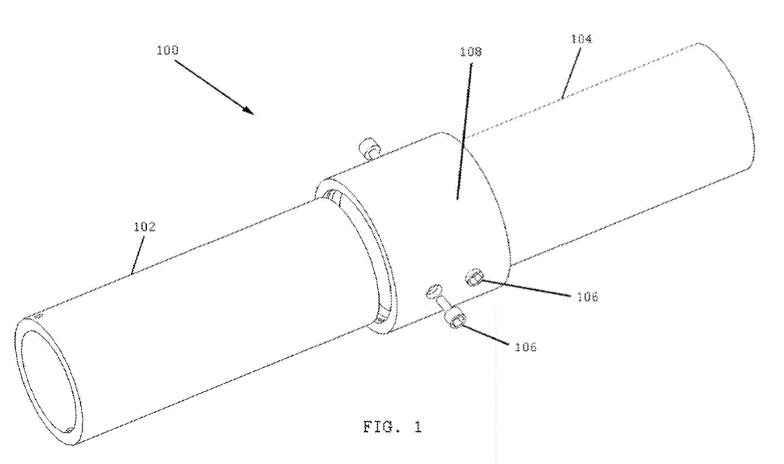

FIG. 1 illustrates a perspective view of a pipe coupler 100 joining a first pipe section 102 and a second pipe section 104. The pipe coupler 100 is installed onto the open ends of both pipes and secured in place using retaining fasteners 106. The pipe coupler 100 can be used to join two pipes that carry liquids or gases at pressures above (or below) atmospheric pressures. In the embodiment shown in FIG. 1, the pipe coupler 100 comprises an external surface 108 that is cylindrical in nature. However, in other embodiments, the external surface of pipe coupler 100 may form other geometries. For example, the external surface 108 may form a cross section that is square, rectangular, triangular, or virtually any other geometry, and does not need to limited to any type of formal geometric figure. It should be understood that the external surface 108 cross section geometry need not match a cross section of pipe sections to be connected. For example, pipe coupler 100 could comprise an external surface 108 cross section that is square, while the cross section of first pipe section 102 and second pipe section is circular.

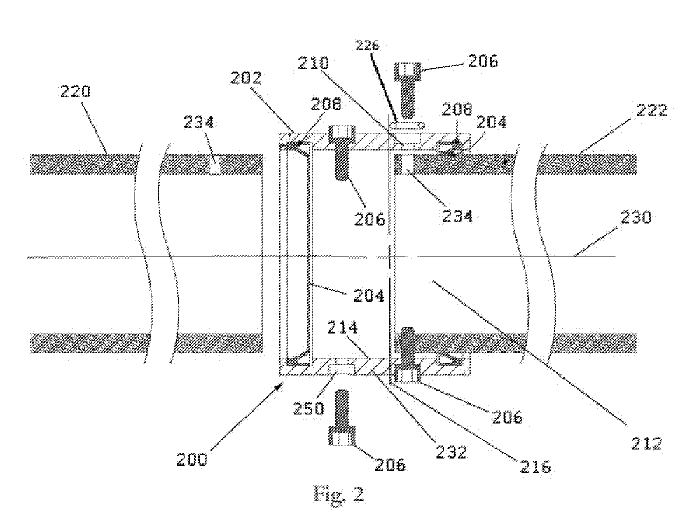

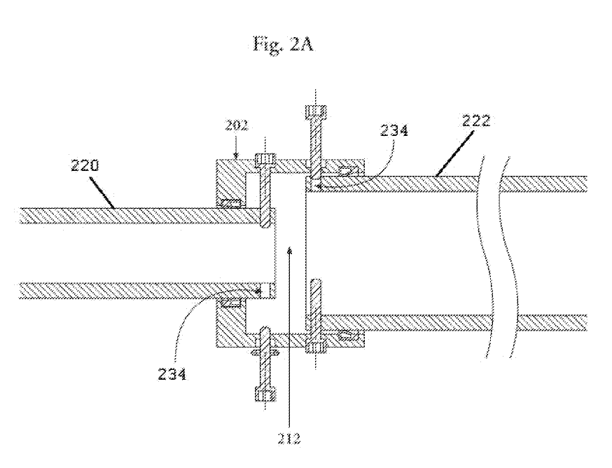

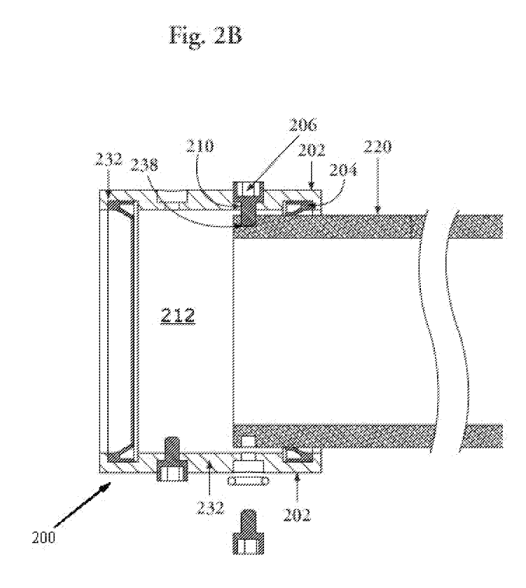

FIG. 2 illustrates a cutaway view of one embodiment of a pipe coupler 200 in use with pipes 220 and 222. In this embodiment, pipe coupler 200 comprises a body 202 having a through hole 212 formed along a central axis 230, two compressible contact seals 204, and retaining fasteners 206. The body 202 serves as the main coupler that houses the compressible contact seals 204 and retaining fasteners 206. The body 202 further comprises sealing grooves 208 that are each designed to retain one of the contact seals 204. The body 202 still further comprises at least two apertures 210 formed through a wall 232 of body 202 for receiving the retaining fasteners 206. The fastening retainers 206 each extend through apertures 234 formed through each of the pipes 220 and 222, as shown, thus forming a mechanical stop to prevent movement of each pipe with respect to the body 202.

Construction of pipe coupler 200 comprises forming body 202 using one of any number of materials currently known in the art. Principal materials can include, but are not limited, to ferrous and non-ferrous metals, plastics and polymers.

Body 202 comprises at least two sealing grooves 208 along an inside surface 214 of body 202. In one embodiment, each sealing groove 208 is formed to a predetermined depth and width into the inside surface 214, generally around a circumference of the inside surface 214. That is, a depression ring is formed along the inside surface 214. The sealing grooves 208 may be formed by cutting or by casting in an embodiment where body 202 is die-cast. Other methods of forming the grooves 204 known in the art may be used in the alternative.

The cross section of the groove 208 may form one of any number of geometric shapes, including a square, rectangular, or half-circular cross section. Of course, other geometries may be used in the alternative. Generally, it is desirous to match the cross section of the sealing groove 208 with a cross section of the contact seal 204. In practice, the cross section of sealing groove 208 may be manufactured to be slightly smaller than the cross section of contact seal 204 to allow for a snug fit between these two entities.

In one embodiment, body 202 comprises two sealing grooves 208, each groove retaining one contact seal 204. In other embodiments, body 202 may comprise more than two groove/seal combinations to accommodate higher working pressures within pipes 220 and 222. In those embodiments, the grooves/seals may or may not be located uniformly along the surface of body 202, and it is not necessary that an equal number of groove/seal combinations exist on each side of mid-point 216. In general, each sealing groove 208 is supplied with one contact seal 204, however this not need be the case. It is contemplated that in some situations, it may be beneficial to use two or more contact seals 204 within each sealing groove 208. The contact seals 204 may be held in place by an adhesive such as rubber cement, “crazy glue”, or other known adhesive. Alternatively, the contact seals 204 and/or sealing grooves 208 may be designed so that each seal forms a snug, physical contact against the sealing groove 208.

Although FIG. 2 illustrates pipes 220 and 222 having the same diameter, it should be understood that in other embodiments, pipe coupler 200 could be used to couple two pipes of different diameters. This may be accomplished by simply increasing the thickness of a contact seal 204 so that an inside diameter of contact seal 204 is reduced to accommodate a smaller-diameter pipe. Alternatively, or in addition, the through hole 212 could be formed using two diameters as shown in FIG. 2a.

Referring back now to FIG. 2, one groove/seal combination is located on a left side of a mid-point 216 of body 202 and the other groove/seal combination is located on a right side of mid-point 216. Each groove/seal combination forms a gas-tight or liquid-tight seal against a respective pipe section. The gas-tight/liquid tight seal is formed by a compression of the contact seal 204 between sealing groove 208 and a surface of a pipe section installed therethrough. The thickness and elasticity of each contact seal 204 may be different depending upon the application for which they are designed. For example, in applications where relatively high working pressures are present, the thickness of the contact seals 204 may be greater and the elasticities may be smaller than seals designed for applications using smaller relative working pressures.

One of the advantages of pipe coupler 200 is that the same body 202 can be used in a variety of coupling applications where the working pressure in each application is different. The contact seals 204 may be chosen such that they are effective over a wide range of working pressures or they may be chosen on an application-specific basis.

It should be mentioned that the preferred placement of apertures 210 with respect to the location of sealing grooves 208 is generally such that the apertures 210 are closer to the mid-point 216 than the sealing grooves 208. However, other arrangements are possible.

In one embodiment, the contact seals 204 comprise a typical, circular cross-sectional o-ring. In another embodiment, what is commonly known as a u-cup or e-seal may be used. The cross-section of each contact seal 204 may be circular, square, rectangular, or almost any shape. The contact seals 204 can be constructed from any one or a combination of polymers, elastomers, rubber, plastic, and/or metal. Generally, the contact seals 204 are made to be compressible. That is, the cross-section of the seals are designed to deform against the sealing grooves 208 and/or the surface of the pipes, tubes, conduits, etc. as pipes are passed through the contact seals during installation of the pipe coupler 200 onto pipe sections.

Body 202 further comprises apertures 210 for receiving retaining fasteners 206. The apertures 210 are generally formed by drilling or punching and typically comprise internal threads for engaging external threads found on retaining fasteners 206. Generally, at least one aperture 210 is required for each pipe to be installed into pipe coupler 200. In other embodiments, multiple apertures may used to further secure pipes to the pipe coupler 200. In those embodiments, the multiple apertures 210 may be located about a circumference of the body 202. The quantity of retaining fasteners and material composition thereof will be incumbent upon the requirements of the application for strength and working pressures.

The retaining fasteners 206 are used to secure pipe coupler 200 to pipes 220 and 222, thereby forming a fixed relationship among these entities. In one embodiment, the fasteners provide an interference or mechanical stop to the pipes to keep each pipe in a fixed relationship with the pipe coupler 200. In this embodiment, an opening 236, such as an aperture, hole, slot, etc., is formed through a pipe wall so that the opening 236 aligns with one of the apertures 210 in body 202 when the pipe is installed into pipe coupler 200.

In another embodiment, a depression 238, rather than opening 236, is formed on the surface of at least one pipe, thus allowing a retaining fastener 206 to provide a mechanical stop to the pipe without intrusion into the interior area of the pipe. This is illustrated in FIG. 2b, showing a close-up, side view of depression 238 formed on the surface of pipe 220 and retaining fastener installed through aperture 210.

In any case, after one of the pipes has been installed into the through hole 212 and a retaining fastener 206 is inserted into aperture 210 and secured into place, the pipe is secured to the pipe coupler 200, thereby preventing movement of the pipe in relation to the pipe coupler 200.

The retaining fastener 206 typically comprises external threads for mating with internal threads of aperture 210. In other embodiments, the retaining fasteners 206 may be secured by other well-known methods in the art, including adhesion, welding, riveting, etc. A well known locking agent such as Locktite® can be used on the threads to provide a pressurized seal to the aperture/fastener interface. In other embodiments, a gasket 226 may be used in conjunction with the retaining fastener 206 and aperture 210 to further ensure a gas/liquid-tight seal between aperture 210 and retaining fastener 206. The gasket 226 may be constructed from any one or a combination of polymers, elastomers, rubbers, plastics, and/or metals and is generally “donut” shaped. In one embodiment, gasket 226 comprises an O-ring. Alternatively, the gasket 226 could be formed by use of a gasket-forming liquid, commonly known as “liquid gasket”.

Each of the retaining fasteners 206 comprises a bolt, screw, or other pin-type fastener that is designed to protrude through aperture 210 and into the opening in the pipes to prevent movement of the pipes with respect to the pipe coupler 200. The retaining fastener 206 is typically secured to aperture 210 by a mating internal/external thread combination. The retaining fasteners 206 can be constructed so that all or only a portion of the fastener is threaded. In one embodiment, an optional receiving gland 250 is also incorporated into the aperture 210 to accommodate a head 240 associated with retaining fastener 206. Various materials and methods commonly known in the art used to manufacture the retaining fasteners.

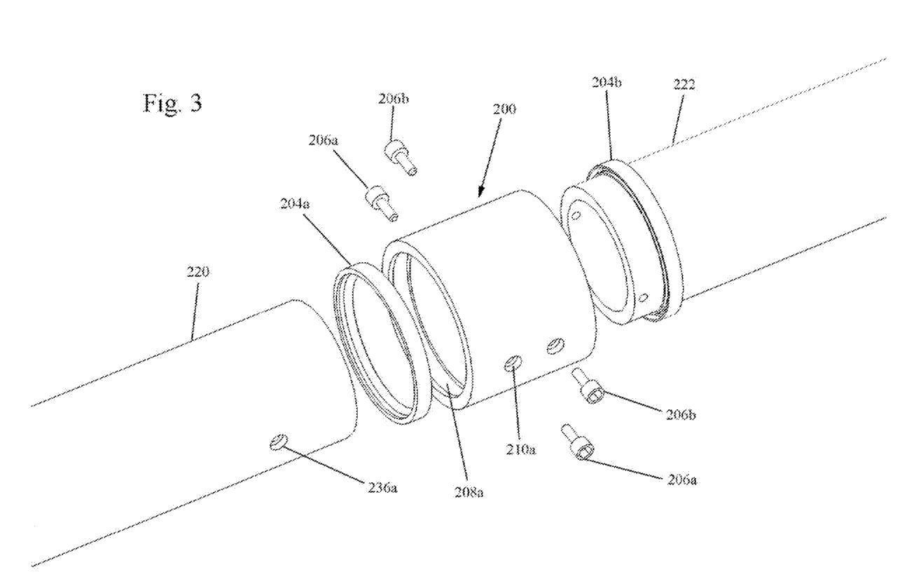

FIG. 3 illustrates an exploded view of the pipe coupler 200 of FIG. 2 and pipe sections 220 and 222. Pipe coupler 200 is used to physically connect and form a pressurized seal between pipes 220 and 222, which are designed to carry gases and/or liquids a given working pressure. Contact seals 204a and 204b are installed into their respective sealing grooves 208a and 208b (not shown) prior to installation of pipe coupler 200. Pipe section 220 is then inserted into through hole 212 to extend past a first contact seal 204a. An external surface of first pipe section 220 comes in contact with an internal diameter of compressible contact seal 204a. A pressurized seal is produced as the contact seal 204a is compressed against the external surface of the first pipe section 220, the sealing groove 208a, and/or an inside diameter of body 202. Each of the pipe sections will generally comprise at least one opening 236a (or depression 238, not shown) formed by drilling, punching, or cutting, to accommodate the diameter of the retaining fastener 206a. The opening 236a and/or depression 238 may also comprise internal threads sized to receive retaining fastener 206a.

As stated previously, first pipe section 220 is inserted into through hole 212 and contact seal 204a, until opening 236a aligns with aperture 210a. At that point, a retaining fastener 206a is inserted through the opening 236 and aperture 210a and held into place, typically by external and internal threads located on retaining fastener 206a and aperture 210a, respectively. In other embodiments, the retaining fastener may be welded or affixed with a bonding material such as epoxy or other adhesive. It should be understood that although FIG. 3 shows a total of four retaining fasteners 206, in other embodiments, a greater or fewer number of retaining fasteners may be used. A second pipe section 222 is then inserted into through hole 212 at the other end of body 202 and held in place with at least one retaining fastener 206b.

Thus, pipe coupler 200 operates to physically connect and form a pressurized seal between pipe sections 220 and 222.

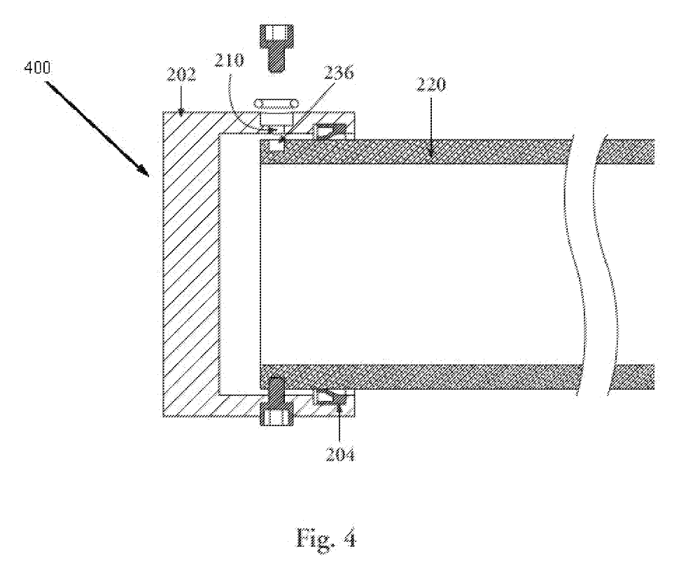

FIG. 4 illustrates a pipe coupler 400 for capping a single pipe, tube, conduit, or the like. In this embodiment, one end of pipe coupler 400 is sealed, as shown. The other features of pipe coupler 400 are similar to the features of pipe coupler 200, previously discussed. That is, pipe coupler 400 comprises at least one sealing groove 401 and corresponding contact seal(s) 402. Pipe coupler 400 further comprises at least one aperture 404 for receiving a corresponding retaining fastener 406. The retaining fastener 406 is used to physically secure pipe coupler 400 to pipe 408, typically through an opening or depression 410 formed through pipe 408, as shown. To cap pipe 408, pipe coupler 400 is placed over the open end of pipe 408 such that the open end of pipe 408 passes through at least one contact seal 402. Pipe 408 continues to be inserted into pipe coupler 400 until an aperture or depression 410 aligns with aperture 404. At that point, a retaining fastener 406 is inserted into aperture 404 and aperture 410 and secured in place. At this point, a pressurized cap to pipe 408 has been achieved.

With respect to the above description, it is to be realized that the optimum dimensional relationships of the various components of the pipe couplers include variations in size, materials, shape, form, function and manner of operation, assembly and use, and are deemed readily apparent and obvious to one skilled in the art. All equivalent relationships to those illustrated in the drawings and described in the specification are intended to be encompassed by the embodiments described herein. Therefore, the foregoing is considered as illustrative only of the principles and descriptions provide herein. Further, since numerous modifications and changes may be contemplated by those skilled in the art, it is not desired to limit the embodiments described herein to the exact construction and operation shown and described, and accordingly, all suitable modifications and equivalents may be resorted to, falling within the scope of the present disclosure.

I claim:

1. A pipe coupler, comprising:
a body comprising an outer surface and a through hole, the through hole defining an inner surface of the body, the body further comprising a first aperture through a wall of the body, a second aperture through the wall of the body, a first sealing groove formed along a circumference of the inner surface and a second sealing groove formed along the circumference of the inner surface;
a first contact seal seated to the first sealing groove for forming a first pressurized seal against a first pipe section;
a second contact seal seated to the second sealing groove for forming second pressurized seal against a second pipe section;
a first retaining fastener for insertion through the first aperture to prevent movement of the first pipe section in relation to the body; and
a second retaining fastener for insertion through the second aperture to prevent movement of the second pipe section in relation to the body.

2. The pipe coupler of claim 1, further comprising:
a first gasket installed onto the first retaining fastener and disposed between the first retaining fastener and the first aperture; and
a second gasket installed onto the second retaining fastener and disposed between the second retaining fastener and the second aperture.

3. The pipe coupler of claim 1, further comprising:
a first receiving gland incorporated into the first aperture for accommodating a head associated with the first retaining fastener.

4. The pipe coupler of claim 1, wherein the through hole comprises a first section and a second section, the first section having a first diameter and the second section having a second diameter different than the first diameter.

5. A pipe coupler, comprising:
a body comprising an outer surface and a through hole, the through hole defining an inner surface of the body, the body further comprising a first aperture through a wall of the body, a second aperture through the wall of the body, a first sealing groove formed along a circumference of the inner surface and a second sealing groove formed along the circumference of the inner surface;
means for forming a first pressurized seal between the inner surface and a first pipe section;
means for forming a second pressurized seal between the inner surface and a second pipe section;
means for retaining the first pipe section within the pipe coupler; and
means for retaining the second pipe section within the pipe coupler.

6. The pipe coupler of claim 5, further comprising:
means for enhancing a third seal between the first retaining means and the first aperture; and
means for enhancing a fourth seal between the second retaining means and the second aperture.

7. The pipe coupler of claim 5, further comprising:
means for receiving a head associated with the first retaining means.

8. The pipe coupler of claim 5, wherein the through hole comprises a first section and a second section, the first section having a first diameter and the second section having a second diameter different than the first diameter.

9. A method for manufacturing a pipe coupling, comprising:
forming a first sealing groove along an inner surface of a body, the inner surface formed by a through hole along a central axis of the body;
forming a second sealing groove along the inner surface of the body;
installing a first contact seal onto the first sealing groove;
installing a second contact seal onto the second sealing groove;
forming a first aperture through a wall of the body for receiving a first retaining fastener; and
forming a second aperture through wall of the body for receiving a second retaining fastener.

10. The method of claim 9, further comprising:
inserting a first pipe section into the through hole and through the first contact seal;
inserting a second pipe section into the through hole and through the second contact seal;
installing the first fastener through the first aperture to secure the first pipe section to the coupling; and
installing the second fastener through the second aperture to secure the second pipe section to the coupling.
